(19) United States
(12) Patent Application Publication
(10) Pub. No.: US 2008/0056748 A1
(43) Pub. Date: Mar. 6, 2008

(54) IMAGE FORMING APPARATUS AND IMAGE FORMING METHOD CAPABLE OF PRINTING IMAGES WITHOUT SPACES THEREBETWEEN

(75) Inventor: Jeong-seok OH, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/744,540

(22) Filed: May 4, 2007

(30) Foreign Application Priority Data
Sep. 4, 2006 (KR) 2006-84871

(51) Int. Cl. G03G 15/14

(52) U.S. Cl. 399/66

(57) ABSTRACT

An image forming apparatus includes an image forming part to form a plurality of images having image areas on a printing medium, a transferring part to transfer the printing medium through the image forming part, and a controller to control the image forming part and the transferring part to stop the transferring of the printing medium if, during sequentially forming the plurality of images, one of the image areas corresponds to a space, and to control the image forming part and the transferring part to restart the transferring of the printing medium if an image area does not correspond to the space.

### CROSS-REFERENCE TO RELATED APPLICATION

This application claims the benefit of Korean Application No. 10-2006-0084871, filed Sep. 4, 2006 in the Korean Intellectual Property Office, the disclosure of which is incorporated herein by reference.

### BACKGROUND OF THE INVENTION

1. Field of the Invention

Aspects of the present invention relate to an image forming apparatus, and more particularly, to an image forming apparatus and an image forming method capable of performing printing of images without spaces therebetween.

2. Description of the Related Art

In general, an image forming apparatus (such as a printer, a photocopier, a facsimile, or a multifunctional device,) forms an image on printing media based on a printing image of a printing object. The printing image can be transmitted from a host apparatus like a computer system. The host apparatus obtains the printing image by scanning an image from a copying object or a scanning object, or can be received through a facsimile communication from another facsimile apparatus.

Typically, the image forming apparatus prints the printing image as an entire page unit. That is, as shown in FIG. 1, a real image 11 exists only in one part of the printing image 1 corresponding to a page, and space 12 exists in the other part. The image forming apparatus, however, uses an entire page 2 to print out the printing image 1 (refer to 2 in FIG. 1). This conventional printing technique is the same as well in the case that the printing image 3 has a plurality of real images when the images 3 are printed on the page 4 (refer to 3 and 4 in FIG. 1). Furthermore, in the case that one page of printing images 5 is reduced in size and printed, the number of images printed on the one page 6 increases, but the shapes of the original document images 5 are kept the same (refer to 5 and 6 in FIG. 1), and thus, the spaces 12 between the original document images remain in the printed images as shown in page 6.

According to the above-described conventional image forming apparatus, in the case that space exists in the printing image, the image printed to the document is printed as a page unit with spaces between the real images. Accordingly, in the case that a user does not want a space to be printed instead of a real image, there is a problem because printing paper, ink, and/or toner is wasted.

In addition, according to the conventional image forming apparatus, even if the real image is printed without printing the spaces in the original document image, the printing is still performed as a page unit, thereby causing another problem. The conventional image forming apparatus gathers real images that are scattered across respective pages and makes a new printing image of one full page size without spaces between the images. However, when the printing is performed in this way, printing is not performed until at least a printing image corresponding to one full page size is completed. Accordingly, there is a problem because this gathering process takes a long time to obtain a printing outcome. Also, this problem becomes serious if a user wants to print more than one page, because the conventional image forming apparatus requires even more time to gather enough images to print out multiple pages without spaces.

### SUMMARY OF THE INVENTION

An aspect of the present invention provides an image forming apparatus and an image forming method capable of rapidly outputting a printing outcome when performing printing of images without spaces therebetween.

Additional aspects and/or advantages of the invention will be set forth in part in the description which follows and, in part, will be obvious from the description, or may be learned by practice of the invention.

According to an aspect of the present invention, an image forming apparatus includes an image forming part to form an image on a printing medium; a transferring part to transfer the printing medium through the image forming part in a transferring direction; and a controller to control the image forming part and the transferring part to stop the transferring of the printing medium in the transferring direction if, while sequentially forming the printing images using the image data, a portion of the image data to be printed corresponds to the space, and to control the image forming part and the transferring part to restart the transferring of the printing medium if the portion of the image data corresponds to one of the printing images.

According to an aspect of the present invention, the image data includes image areas which are formed as a line unit.

According to an aspect of the present invention, the image forming apparatus further includes a scanning part to scan a scanning object and to generate the printing images based on the scanned scanning object.

According to an aspect of the present invention, the image forming apparatus further includes a user inputting part to receive a command, wherein the controller controls the image forming part to perform printing according to the received command.

According to an aspect of the present invention, the controller controls the image forming part and the transferring part to form the image throughout a plurality of printing media in the case that printing with respect to a plurality of the printing images which cannot all fit on the printing medium is performed.

According to an aspect of the present invention, an image forming method includes stopping a transfer of a printing medium if, while sequentially forming an image having a plurality of image areas including printing images and a space not within the printing images, one of the image areas corresponds to the space; and restarting the transfer of the printing medium if another of the image areas immediately following the one image area includes one of the printing images and does not correspond to the space.

According to an aspect of the present invention, each of the image areas is formed as a line unit.

According to an aspect of the present invention, the image forming method further includes scanning a scanning object and generating the printing images based on the scanned scanning object.

According to an aspect of the present invention, the image forming method further includes receiving a command, wherein the printing stage is performed according to the received command.

According to an aspect of the present invention, wherein during printing the image is formed throughout a plurality of printing media in the case that printing with respect to a plurality of printing images which cannot all fit on the one printing medium is performed.

### BRIEF DESCRIPTION OF THE DRAWINGS

These and/or other aspects of the present invention will become apparent and more readily appreciated from the following description of the embodiments, taken in conjunction with the accompanying drawings, of which:

FIG. 1 is a drawing illustrating printing images and printing outcomes according to a conventional image forming apparatus;

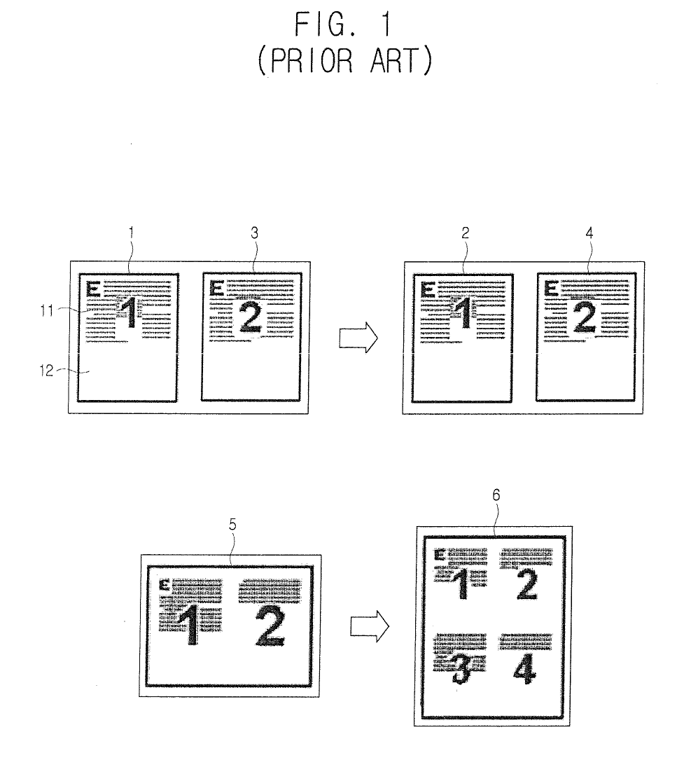

FIG. 2 is a block diagram illustrating a configuration of an image forming apparatus according to an embodiment of the present invention;

FIG. 3 is a flow diagram illustrating an operating process of the image forming apparatus illustrated in FIG. 2; and

FIG. 4 is a drawing illustrating printing images and printing outcomes according to the image forming apparatus illustrated in FIG. 2.

### DETAILED DESCRIPTION OF EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures. The same elements are given the same reference numerals in various embodiments, and they will be typically described in a first embodiment, and will be omitted in the other embodiments.

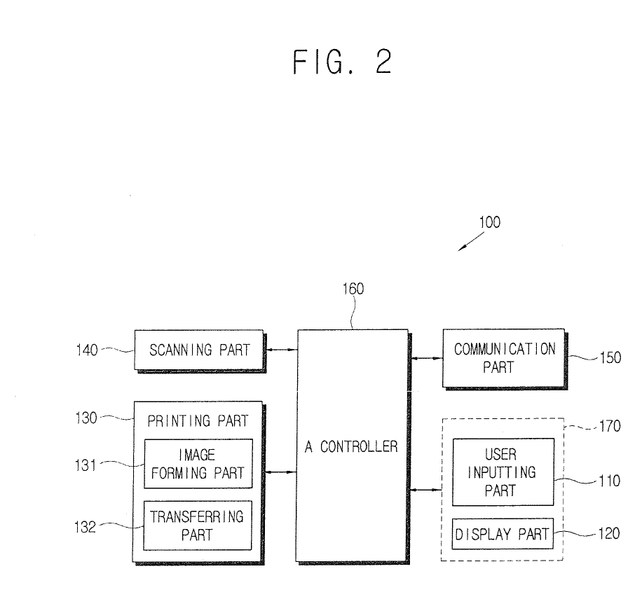

FIG. 2 is a block diagram illustrating a configuration of an image forming apparatus 100 according to an embodiment of the present invention. The image forming apparatus 100 can be various types, such as, for example, a printer, a facsimile, a photocopier, or a multi-functional device. The image forming apparatus 100 forms an image on printing media (such as paper, transparency sheets, etc.) to perform printing. The printing images can be obtained by the image forming apparatus 100 in many ways. For example, the printing images can be transmitted from a host apparatus (not shown) like a computer system, can be obtained by performing scanning or copying with respect to a copying object or a scanning object, can be received from another facsimile apparatus through a facsimile communication, or can be received from portable media, across a network or other like media.

The image forming apparatus 100 sequentially performs printing on a plurality of areas on a printing medium to form the printing images. The areas of the printing images according to an embodiment of the present invention correspond to a line as a printing unit. However, it is understood that the printing unit is not limited to a single line, may be multiple lines or a fraction of a line, and may be areas of varying thickness in a printing direction of the medium and/or width in a direction perpendicular to the printing direction.

The image forming apparatus 100 determines whether areas of the printing images correspond to spaces. These areas which the image forming apparatus 100 analyzes are also referred to as concerned areas. If a concerned area corresponds to space, the image forming apparatus 100 does not form an image on this area. The image forming apparatus 100 forms an image on a concerned area when the concerned area does not correspond to space.

Using the above-described method, the image forming apparatus 100 enables printing images to be formed adjacent to each other when an image is formed, thereby preventing printing paper, ink, and/or toner from being wasted. In particular, the image forming apparatus 100 determines whether there are spaces in any of the plurality of areas which form the printing images, and sequentially forms an image according to the determined result. Therefore, since the conventional operation for forming a new printing image based on gathered images which form at least an entire page does not need to be performed, the printing outcome can be outputted more rapidly.

As shown in FIG. 2, the image forming apparatus 100 includes a printing part 130 and a controller 160. The printing part 130 performs printing by forming an image on printing media according to commands which are executed by the controller 160. The printing part 130 includes an image forming part 131 for forming an image. The image forming part 131 can form an image through ink jetting, or through other known methods in the art, such as laser printing. In the case of an image forming apparatus 100 which uses ink jetting, the image forming part 131 may include a print head (not shown) for jetting ink according to inputted printing data, and a carriage (not shown) for loading the print head. Also, the image forming part 131 may further include a motor part (not shown) for transferring the carriage to a sub scanning direction with respect to the printing media, and a driving mechanism (not shown) driven by the motor part.

Furthermore, the printing part 130 includes a transferring part 132 for transferring print media to the image forming part 131. The printing part 130 may further include a feeding part (not shown) for feeding printing media, the transferring part 132 for transferring the fed printing media to the print head, and a discharging part (not shown) for discharging the printing media on which an image is formed. The feeding part, the transferring part 132, and the discharging part respectively feed, transfer, and discharge the printing media at proper times according to commands inputted to the controller 160. Specifically, the transferring part 132 transfers the printing media in a main scanning direction with respect to the print head or stops transferring to perform printing as a line unit according to commands inputted to the controller 160. The image forming part 131 forms the image in each line unit, which extends in a subscanning direction that is substantially perpendicular to the main scanning direction.

The controller 160 determines which, if any, of the plurality of areas forming the printing images corresponds to a space. If the controller 160 determines that a concerned area (i.e., an area about to be printed) does not correspond to a space, the image corresponding to this concerned area is formed to be adjacent to another image. If the controller 160 determines that a concerned area corresponds to a space, the image corresponding to this concerned area is not formed. The controller 160 controls the printing part 130 to sequentially perform an operation to determine which areas correspond to spaces and an operation to form images with respect to each of the plurality of areas that does not correspond to a space. The space is a blank area, where the size of the blank area qualifying as a space can be predefined or set by a user.

The controller 160 controls the image forming part 131 and the transferring part 132 to form the image based on the printing data with respect to the concerned area if the concerned area does not correspond to space. The controller 160 controls the image forming part 131 and the transferring part 132 to not perform the image forming operation if the concerned area corresponds to a space. By way of example, the controller 160 controls the transferring part 132 to stop transferring the printing media in the subscanning direction if the controller 160 determines that a concerned area corresponds to an empty space.

While not required in all aspects, the controller 160 is provided to function with a computer program. In this case, the controller 160 includes a nonvolatile memory (not shown) such as a flash memory in which a source code of the computer program is stored, a volatile memory (not shown) such as a RAM for reading the source code from the flash memory for temporary storage, and a processor (not shown) such as a CPU for performing commands based on the source code stored in the RAM. Furthermore, aspects of the invention can be implemented using computer software stored on a medium for use by a computer and/or controller. The computer readable recording medium is any data storage device that can store data which can be thereafter read by a computer system. Examples of computer readable recording media include read-only memory (ROM), random-access memory (RAM), CD-ROMs, magnetic tapes, floppy disks, optical data storage devices, and a computer data signal embodied in a carrier wave comprising a compression source code segment and an encryption source code segment (such as data transmission through the internet). The computer readable recording medium can also be distributed over network coupled computer systems so that the computer readable code is stored and executed in a distributed fashion.

The printing images according to an embodiment of the present invention can be transmitted to the image forming apparatus 100 in a variety of fashions. For example, the images can be transmitted from a host apparatus (not shown) such as a computer system, obtained from a scanner which copies or scans a copying object or a scanning object, or received through a facsimile communication from another facsimile apparatus (not shown). The image forming apparatus 100 further includes a communication part 150 for performing a data communication with the host apparatus so as to receive a printing image from the host apparatus.

Also, an example of the image forming apparatus 100 further includes a scanning part 140 to perform scanning of a copying object or a scanning object in order to generate printing images. Furthermore, an example of the communication part 150 includes a modem (not shown) and/or a line interface part (not shown) to perform a facsimile communication and receive printing images from another facsimile apparatus. The scanning part 140 and the communication part 150 respectively perform scanning and facsimile communicating operations according to commands inputted to the controller 160.

The image forming apparatus 100 further includes a user inputting part 110 and a display part 120 which enable a user to interface with the image forming apparatus 100. The user inputting part 110 receives a printing command inputted by a user and transmits the printing command to the controller 160. The display part 120 displays the printing information for a user to see. The user inputting part 110 and the display part 120 are integrally provided in the shape of an operation panel (OPE) 170. The user inputting part 110 includes a manipulating panel having a plurality of buttons to input commands. Examples of the display part 120 include an LED and an LCD to display an operation state. An example of the user inputting part 110 includes a specific button which a user presses to perform the function of printing images without space therebetween. However, it is understood that the user inputting part 110 and the display part 120 can be otherwise located, and can be combined.

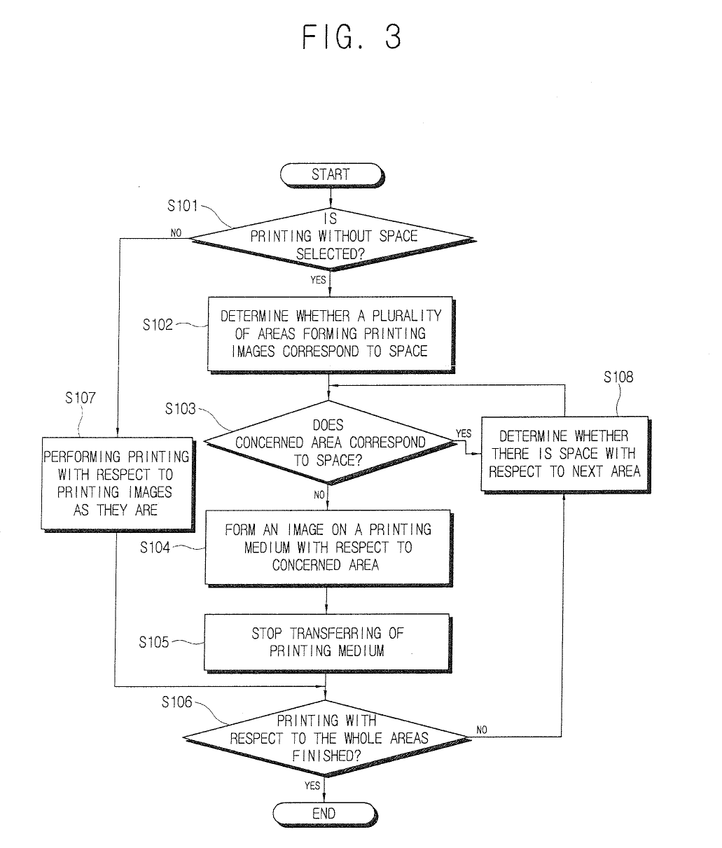

FIG. 3 is a flow diagram illustrating an operation of the image forming apparatus 100 according to an embodiment of the present invention. First, the controller 160 determines whether the user selects printing images without spaces therebetween with respect to a predetermined printing image at operation S101. If the controller 160 determines that the user has not selected printing images without space therebetween at operation S101, the controller 160 controls the printing part 130 to perform a normal printing operation of the original document image with respect to the concerned printing image at operation S107, and then performs operation S106.

If the controller 160 determines that the user has selected printing images without space therebetween at operation S101, the controller 160 sequentially determines whether any of the plurality of areas forming the printing image corresponds to a space at operation S102. If the controller 160 determines that any of the concerned areas corresponds to a space at operation S103, the controller 160 determines whether the next area corresponds to a space at operation S108. Thereafter, the controller 160 repeats operation S103.

If the controller 160 determines that the concerned area does not correspond to a space at operation S103, the controller 160 controls the printing part 130 to form an image corresponding to the concerned area on the printing media at operation S104. When printing with respect to the concerned area is completed, the controller 160 controls the transferring part 132 to stop transferring the printing media at operation S105.

Thereafter, the controller 160 determines whether printing with respect to the whole area is completed at operation S106. The whole area refers to the entire image which is to be printed, and the whole area may fit into one page or span a plurality of pages depending on the size of the entire image. In the case that printing with respect to a plurality of pages is performed, the controller 160 determines whether printing with respect to each of the whole pages is completed. If the controller 160 determines at operation S106 that printing with respect to each of the whole pages is completed, the controller 160 stops operating. If the controller 160 determines at operation S106 that printing with respect to each of the whole pages is not completed, the controller 160 determines whether there is a space with respect to the next area in a next one of the pages at operation S108, and repeats operation S103.

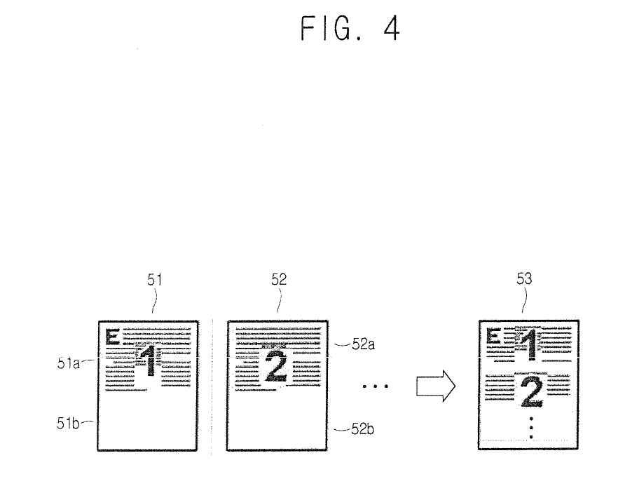

FIG. 4 is a drawing illustrating printing images and printing results according to an embodiment of the present invention. As shown in FIG. 4, in the case that there are real images 51a and 52a and spaces 51b and 52b respectively located in the printing images 51 and 52 of the original document, the printing according to an embodiment of the present invention is performed to thereby obtain a printing outcome 53 without spaces 51b, 52b between the printing images 51a, 52a.

An embodiment of the present invention has been described above in detail, but the present invention is not limited thereto. For example, the image forming part 131 is described for use with an ink jet type image forming apparatus in the above-described embodiment, but the image forming type is not limited thereto, and may instead be applied to other types of image forming apparatuses, such as laser printers.

As described above, the image forming apparatus and an image forming method according to aspects of the present invention can rapidly output a printing outcome to perform printing of images without spaces therebetween. Accordingly, supplies such as printing paper, ink, and/or toner are prevented from being wasted. Also, aspects of the present invention determine whether there is space using a predetermined area unit without generating and storing a new printing image. Accordingly, printing is directly performed if there is no space, and the printing outcome is rapidly outputted, thereby enhancing the convenience of printing for users.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An image forming apparatus to form an image from image data comprising printing images and a space not within one of the printing images, comprising:
an image forming part to form the image on a printing medium;
a transferring part to transfer the printing medium through the image forming part in a transferring direction; and
a controller to control the image forming part and the transferring part to stop the transferring of the printing medium in the transferring direction if, while sequentially forming the printing images using the image data, a portion of the image data to be printed corresponds to the space, and to control the image forming part and the transferring part to restart the transferring of the printing medium if the portion of the image data corresponds to one of the printing images

2. The image forming apparatus according to claim 1, wherein the image data comprises image areas which are each formed as a line unit.

3. The image forming apparatus according to claim 1, further comprising a scanning part to scan a scanning object and to generate the printing images based on the scanned scanning object.

4. The image forming apparatus according to claim 1, further comprising a user inputting part to receive a command, wherein the controller controls the image forming part to perform printing according to the received command.

5. The image forming apparatus according to claim 1, wherein the controller controls the image forming part and the transferring part to form the image throughout a plurality of printing media in the case that printing with respect to a plurality of printing images which cannot all fit on the printing medium is performed.

6. The image forming apparatus according to claim 1, wherein the space separates the image data onto separate printing media, and the controller controls the image forming part and the transferring part to combine the image data onto the printing medium by not transferring the printing medium when a portion of the image data to be printed corresponds to the space.

7. An image forming method, comprising:
stopping a transfer of a printing medium if, while sequentially forming an image having a plurality of image areas including printing images and a space not within one of the printing images, one of the image areas corresponds to the space; and
restarting the transfer of the printing medium if another of the image areas immediately following the one image area includes one of the printing images and does not correspond to the space.

8. The image forming method according to claim 7,
wherein each of the image areas is formed as a line unit.

9. The image forming method according to claim 7, further comprising scanning a scanning object and generating the printing images based on the scanned scanning object.

10. The image forming method according to claim 7, further comprising receiving a command, wherein printing is performed according to the received command.

11. The image forming method according to claim 7, wherein during printing the image is formed throughout a plurality of printing media in the case that printing with respect to a plurality of printing images which cannot all fit on the one printing medium is performed.

12. The image forming method according to claim 7, wherein the space separates the image areas onto separate printing media, and the stopping and the restarting of the transferring of the printing medium is controlled to fit the image areas onto the printing medium.

13. An image forming method to form a printed image from image data including images, comprising:
identifying within the image data a space portion and an image portion;
controlling a transfer part to stop transferring of a printing medium when an image forming part would form the space portion; and
controlling the transfer part to transfer the printing medium after the image forming part would have formed the space portion such that the image forming portion forms the image portion.

14. The image forming method according to claim 13, further comprising, prior to the identifying of the space portion:
controlling the transfer part to begin transferring the printing medium through the image forming part; and
controlling the image forming part to begin forming the image portion.

15. The image forming method according to claim 13, wherein each line of the image data is identified to identify the space portion.

16. The image forming method according to claim 13, wherein the image data is transmitted from a scanned object.

17. The image forming method according to claim 13, further comprising receiving a command, wherein the forming of the printed image is performed according to the received command.

18. An image forming apparatus, comprising:
an image forming part to form an overall image having a plurality of images and a space on a printing medium;
a transferring part to transfer the printing medium through the image forming part; and
a controller to identify the space while the image forming part forms the overall image, to control the transferring part to stop the transferring of the printing medium when the image forming part would form the space instead of one of the plurality of images, and to control the transferring part to transfer the printing medium after the image forming part would have formed the space such that the image forming part forms a next one of the images on the printing medium.

19. The image forming apparatus according to claim 18, wherein each line of the overall image is identified to identify the space.

20. The image forming apparatus according to claim 18, wherein the overall image is transmitted from a scanned object.

21. The image forming apparatus according to claim 18, further comprising a user inputting part to receive a command, wherein the controller controls the image forming part to form the overall image according to the received command.

22. An image forming method, comprising:
receiving an image to be printed which has image areas and at least one space; and
controlling a transfer part to selectively move a printing medium on which the image is to be printed according to the image areas.

23. The image forming method according to claim 22, wherein the transfer part is controlled to stop transferring the printing medium through the image forming part when the at least one space should be printed.

24. A computer readable medium encoded with processing instructions to implement the image forming method of claim 22 using a computer.

25. The image forming method according to claim 22, wherein each line of the image is identified to identify the space.

26. The image forming method according to claim 22, wherein the image is transmitted from a scanned object.

27. The image forming method according to claim 22, further comprising receiving a command through a user inputting part, wherein the controlling is performed according to the received command.
